(19) United States
(12) Patent Application Publication
(10) Pub. No.: US 2006/0032726 A1
(43) Pub. Date: Feb. 16, 2006

(54) Optical inspection system for reconstructing three-dimensional images of coins and for sorting coins

(76) Inventors: Dietrich W. Vook, Los Altos, CA (US); Richard L. Baer, Los Altos, CA (US); Xuemei Zhang, Mountain View, CA (US); S. Jeffrey Rosner, Palo Alto, CA (US); Izhak Baharav, Palo Alto, CA (US)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/915,282

(22) Filed: Aug. 10, 2004

(51) Int. Cl. G07D 5/00

(52) U.S. Cl. 194/328

(57) ABSTRACT

A coin inspection system including a coin passageway, an illumination apparatus to illuminate at least one coin positioned on the coin passageway, a sensing apparatus positioned to receive light reflected from the coin and a processing apparatus to reconstruct a three-dimensional image of the coin based on the reflected light.

### TECHNICAL FIELD

The technical field of this disclosure is coin inspection systems, particularly, optical coin inspection systems, which utilize a three-dimensional solid shape modeling technology to identify and sort coins.

### BACKGROUND OF THE INVENTION

Conventional coin inspection systems currently identify and sort coins based on the coin parameters, such as the size, weight and electromagnetic properties. These coin inspection systems cannot distinguish between real coins and counterfeit coins that have the same physical properties of a real coin. Additionally, coins of different countries have different coin parameters. Thus, the hardware in a coin inspection system used to identify and sort coins from one country must be modified to identify and sort coins of a different country.

In conventional optical inspection systems, the data collected is used to produce a two-dimensional image of a three-dimensional metallic object, such as a coin. Adameck, Hossfeld and Eich in the publication Three Color Selective Stereo Gradient Method for Fast Topography Recognition of Metallic Surfaces describe one such method.

It would be desirable to have a coin inspection and sorting system that does not suffer from the above disadvantages.

### SUMMARY OF THE INVENTION

Embodiments of the present invention provide an optical inspection system operable to capture two or more two-dimensional images of an at least partially specular coin under different illumination configurations and to reconstruct a three-dimensional image of the shape of the surface of the coin from the two or more two-dimensional images.

One aspect of the present invention provides a coin inspection system that includes a coin passageway and an illumination apparatus to illuminate at least one coin positioned on the coin passageway. A sensing apparatus is positioned to receive light reflected from the coin and a processing apparatus reconstructs a three-dimensional image of the coin based on the reflected light.

A second aspect of the invention provides method for inspecting coins. A coin is received on a coin passageway and the received coin is illuminated. Reflected light from the coin is sensed and a three-dimensional image based on the reflected light is reconstructed.

A third aspect of the invention provides a coin inspection system comprising means for receiving a coin on a coin passageway, means for illuminating the received coin, means for sensing reflected light from the coin and means for reconstructing a three-dimensional image based on the reflected light.

The above and other features and advantages of the invention will become further apparent from the following detailed description of the presently preferred embodiments, read in conjunction with the accompanying drawings. The detailed description and drawings are merely illustrative of the invention, rather than limiting the scope of the invention being defined by the appended claims and equivalents thereof.

### BRIEF DESCRIPTION OF THE DRAWINGS

FIG. 1 is a block diagram of a coin inspection system;

FIGS. 2-5 are schematic views of a coin inspection system according to a first embodiment of the invention;

FIG. 6 is a flow chart of a method according to the invention for inspecting coins;

FIG. 7 is a schematic cross sectional view of a coin inspection system according to a second embodiment of the invention;

FIG. 8 is a block diagram of a coin inspection system according to a third embodiment of the invention; and

FIG. 9 is a side view of an alternative embodiment of an illumination apparatus for use in a coin inspection system of FIGS. 2-8 according to the invention.

### DETAILED DESCRIPTION OF THE PRESENTLY PREFERRED EMBODIMENTS

The invention is based on the observation that coin inspection systems do not provide three-dimensional imaging determination of monetary value and authenticity. In accordance with this invention a method and system to model a coin in three dimensions allows for the highly accurate determination of a value of a coin and the authenticity of the coin.

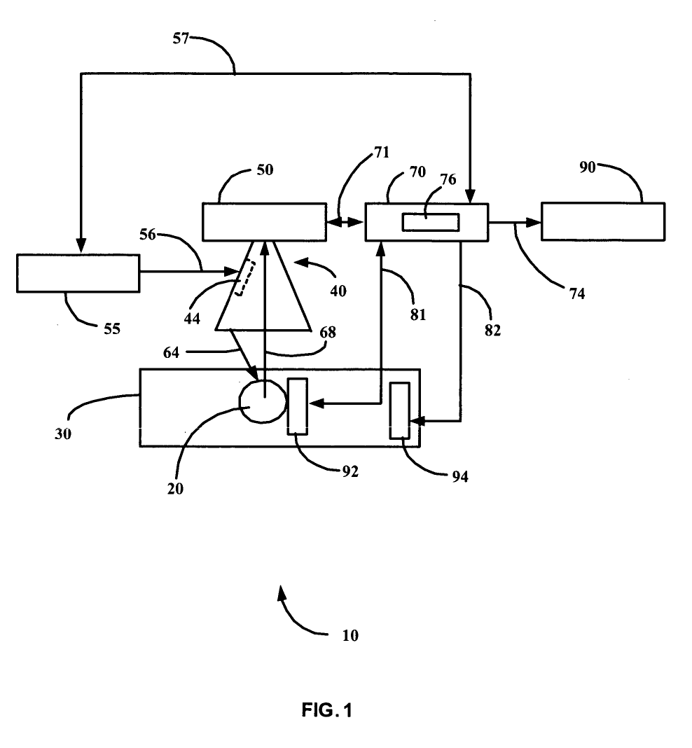

FIG. 1 shows a block diagram of the coin inspection system 10 with coin sorting capability. Coin inspection system 10 includes a coin passageway 30, an illumination apparatus 40, a sensing apparatus 50 and a processing apparatus 70. The illumination apparatus 40 illuminates at least one coin 20 positioned on the coin passageway 30 with light 64. The term “on the coin passageway” includes any arrangement in which the illumination apparatus 40 can illuminate the coin, such as, on a belt, in a track or grooved slide or within a grooved slide. A light control circuit 55 is in communication with the illumination apparatus 40 via connection 56 and with the processing apparatus 70 via connection 57. The light control circuit 55 is operable to selectively activate one or more light emitting elements 44 within the illumination apparatus 40 in pre-established light patterns. The pre-established light patterns shown as light 64 have respective illumination gradients that are incident on the coin 20.

A sensing apparatus 50 is positioned to receive light 68 reflected from the coin 20. Sensing apparatus 50 may be a camera or CCD array. The sensing apparatus 50 is in communication with the processing apparatus 70 via connection 71. Connection 71 is operable to transmit image data sets from sensing apparatus 50 to the processing apparatus 70.

Connection 71 is also operable to transmit synchronizing signals from processing apparatus 70 to sensing apparatus 50. Connection 57 is operable to transmit synchronizing signals from processing apparatus 70 to light control circuit 55. The synchronizing signals synchronize the generation of the appropriate illumination gradients by the illumination apparatus 40 with the sensing of the reflected light 68 by the sensing apparatus 50.

The processing apparatus 70 is operable to reconstruct a three-dimensional image of the coin 20 based on the reflected light 68, to determine a monetary value of the coin 20 and/or to direct movement of coin 20. The processing apparatus 70 includes a memory 76. A display 90 operable to display the three-dimensional image of the coin 20 is in communication with the processing apparatus 70 via connection 74. The processing apparatus 70 is in communication with a releasable stop 92 and a guiding mechanism 94, via connections 81 and 82, respectively.

The releasable stop 92 positioned in the coin passageway 30 is operable to hold the coin 20 in position in front of the illumination apparatus 40. The guiding mechanism 94, which is positioned in proximity to the coin passageway 30, is operable to sort coin 20 based on the determined monetary value.

Connections 56, 57, 71, 74, 81 and 82 may be any connection operable to communicate signals and information. Connections include electrical connections, such as metallic wires and printed circuit board traces, optical connections, such as optical waveguides or optical fibers, wireless connections, such as WiFi, or a combination thereof.

When coin 20 is positioned by releasable stop 92, a signal is sent via connection 81 to processing apparatus 70. Processing apparatus 70 then signals the light control circuit 55 via connection 57 to initiate an illumination process. An illumination process includes shining a sequence of two or more pre-established light patterns from light emitting element 44 on coin 20. Light control circuit 55 signals processing apparatus 70 when the illumination process is complete. The sensing apparatus 50 transmits image data sets to processing apparatus 70.

Processing apparatus 70 reconstructs a three-dimensional image of the coin 20 based on the received image data sets and determines a monetary value of coin 20. The monetary value is determined by matching the reconstructed three-dimensional image with one of the three-dimensional images stored in memory 76 and retrieving a monetary value correlated with the matched dimensional image. The processing apparatus 70 then transmits a signal via connection 82 to guiding mechanism 94 operable to position guiding mechanism 94 based on the determined monetary value. The processing apparatus 70 then transmits a signal via connection 81 to releasable stop 92 to release coin 20. The coin is directed to a location for like coins by the guiding mechanism 94 to complete the sorting operation.

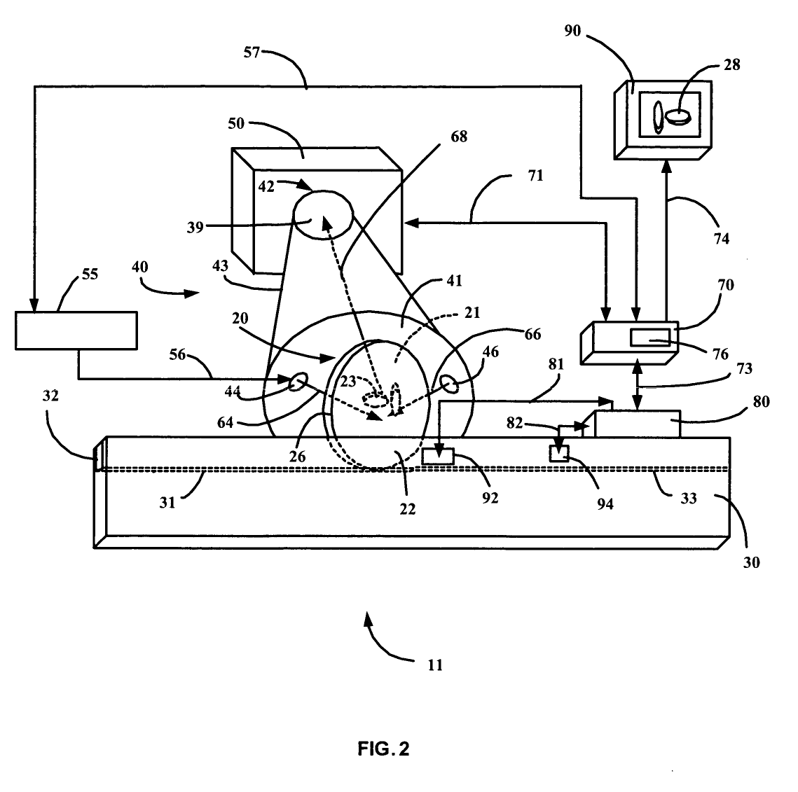

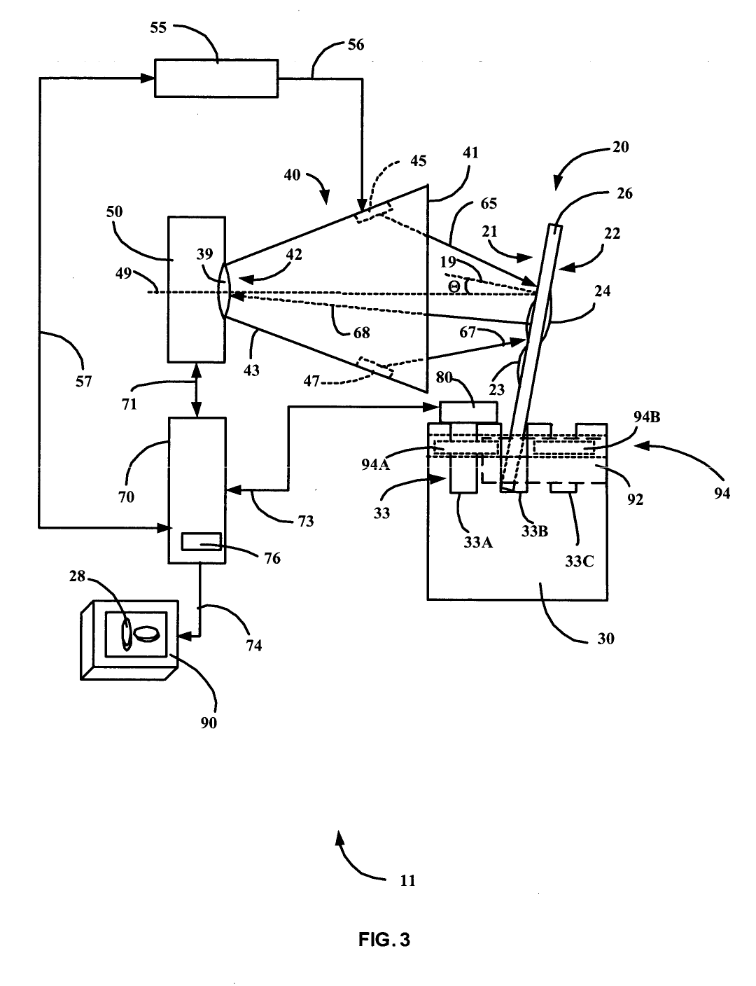

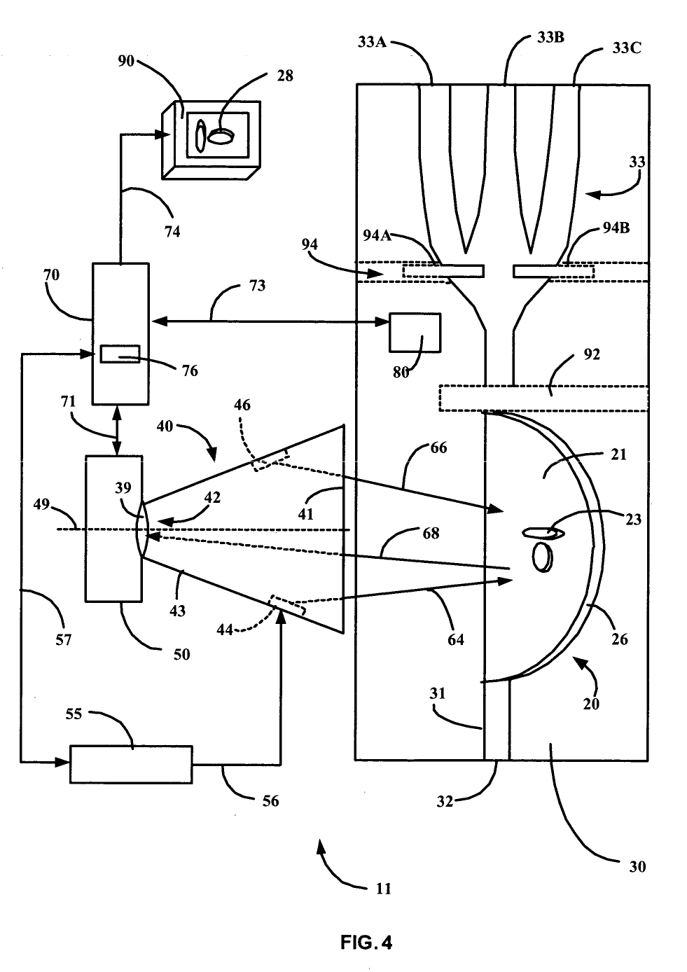

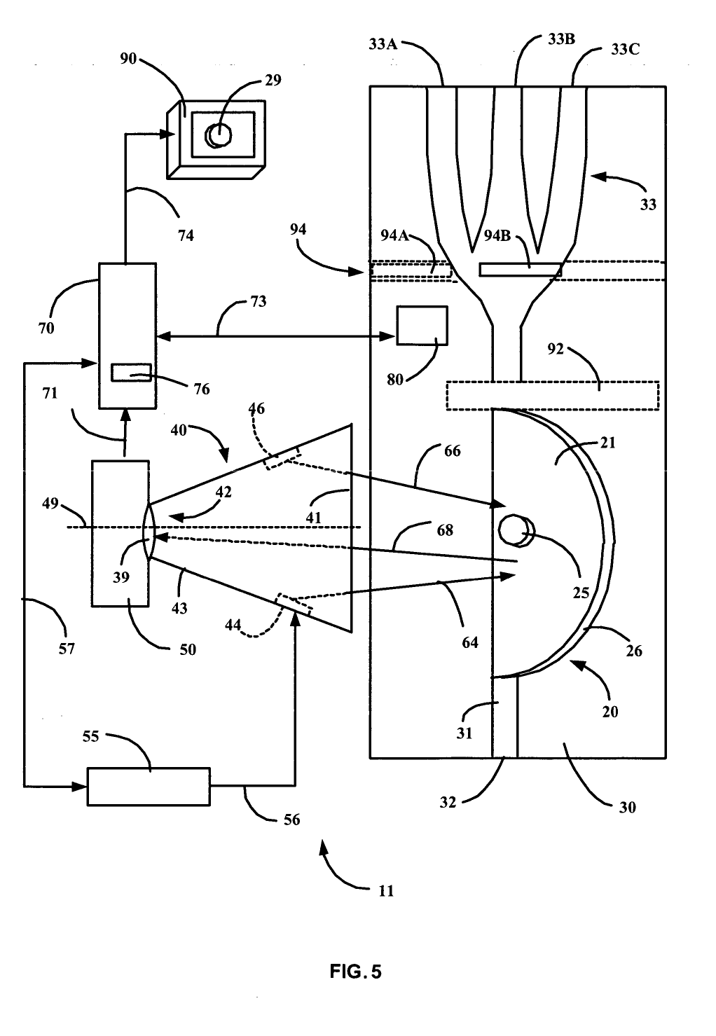

FIGS. 2-5 show a first embodiment of the coin inspection system 11 with coin sorting capability. FIG. 2 shows an oblique view of a coin inspection system 11 capable of rendering a three-dimensional image 28 of at least a portion of surface 21 of the coin 20. The coin inspection system 11 is additionally capable of sorting coins 20 based on a determined value. FIG. 3 shows a side view of the coin inspection system 11. FIG. 4 shows a top view of the coin inspection system 11 operable to sort a coin 20 to a channel 33B. FIG. 5 shows a top view of the coin inspection system 11 operable to sort a coin 20 to a channel 33A.

The coin 20 has a front surface 21, a back surface 22 and an edge 26. The front surface 21 has three-dimensional markings 23 and back surface 22 has three-dimensional markings 24 as shown in FIG. 3. FIG. 5 shows an alternative set of three-dimensional markings 25 for a different coin 20.

In one embodiment, the coin passageway 30 is a conveyer system operable to position the surface 21 in front of the illumination apparatus 40. The coin passageway 30 includes an input end 32 and a single grooved slide 31 that merges into a triple grooved slide region 33. A releasable stop 92 intersects a portion of the single groove slide 31 to position the coin 20 in front of the illumination apparatus 40 during an inspection process. A guiding mechanism 94 is in proximity to the triple grooved slide region 33 of coin passageway 30.

The illumination apparatus 40 is shown as a conical element 43 having a large opening 41 that opposes a small opening 42. Large opening 41 and small opening 42 are aligned about a conical axis 49. Light emitting elements 44-47 are positioned within the conical element 43. The four light emitting elements shown in FIGS. 2-5 represent many light emitting elements or sets of light emitting elements positioned within the conical element 43. The light emitting elements 44-47 are disposed in concentric circular arrays around the axis 49 orthogonal to the plane of surface 21 of coin 20. The light emitting elements 44-47 produce an illumination gradient across at least a contiguous portion of the light emitting elements 44-47. The light emitting elements 44-47 can be light emitting diodes, edge-emitting lasers, vertical-cavity-surface-emitting lasers, incandescent light sources with color filters or any combination thereof.

In one embodiment, the light emitting elements 44-47 arranged in a circular array around the conical axis 49 are divided into sections and each of the sections independently illuminates the coin. In one embodiment, the light emitting elements 44-47 within a section all have the same emission wavelength. In one embodiment, the light emitting elements 44-47 are disposed in concentric circular arrays around the axis 49 almost orthogonal to the plane of surface 21 of coin 20. In this latter embodiment, there is an angle of a less than a few degrees between the normal 19 (FIG. 3) and the axis 49.

Any surface that is rotationally symmetric about the conical axis 49 can replace the conical element 43 within the illumination apparatus 40. In one embodiment, the conical element 43 is a dome shaped structure holding light emitting elements 44-47. In this alternative embodiment, the dome shaped structure has a small opening and a large opening.

A light control circuit 55 is in communication with the light emitting elements 44-47 of the illumination apparatus 40 via connection 56. In FIGS. 2-5, connection 56 is shown as connected to only one of the light emitting elements 44-47 for clarity. The connection is representative of a connection to each and every light emitting element 44-47 for separate control of each and every light emitting element 44-47. The light control circuit 55 is also in communication with the processing apparatus 70 via connection 57. Connection 57 is operable to transmit a signal from processing apparatus 70 instructing light control circuit 55 to selectively activate the one or more of the light emitting elements 44-47 in pre-established light patterns. The pre-established light patterns have respective illumination gradients, which are incident on the surface 21 of the coin 20. Connection 57 is also operable to transmit a signal indicating the completion of an illumination process from the light control circuit 55 to processing apparatus 70.

In one alternative embodiment, the light control circuit 55 is internal to the processing apparatus 70, which is connected to each and every one of the light emitting elements 44-47. In another alternative embodiment, the light control circuit 55 is internal to the controller 80, which is connected to each and every one of the light emitting elements 44-47. In yet another alternative embodiment, controller 80 is internal to the processing apparatus 70.

A light sensitive region of the sensing apparatus 50 is positioned near the small opening 42 to receive the reflected light 68 transmitted through a lens 39 in or near the small opening 42. The sensing apparatus 50 is operable to obtain images of light 68 reflected from the coin 20 under the illumination gradients while the coin 20 is maintained in a constant spatial relationship with the sensing apparatus 50. In one embodiment, the lens 39 is an integral component of the sensing apparatus 50. The light sensitive region of sensing apparatus 50 may be a camera or CCD array that can produce image data sets from the raw pixel values that represent the intensity of the reflected light. When the sensing apparatus 50 captures an image of the surface of the coin 20, the image contains contributions from light emitting elements 44-47 at a range of locations in the illumination apparatus 40. The sensing apparatus 50 is in communication with the processing apparatus 70 via connection 71.

Connection 71 is operable to transmit image data sets to the processing apparatus 70. Connection 71 is also operable to transmit synchronizing signals from the processing apparatus 70 to sensing apparatus 50. Connection 57 is operable to transmit synchronizing signals from the processing apparatus 70 to light control circuit 55. The synchronizing signals synchronize the generation of the appropriate illumination gradients by the illumination apparatus 40 with the sensing of the reflected light 68 by the sensing apparatus 50.

The processing apparatus 70 reconstructs a three-dimensional image of the coin 20 based on the received image data sets and determines a monetary value of the coin 20. The processing apparatus 70 can be a microprocessor, microcontroller, or other type of processing device capable of performing the functions described herein. In addition, the processing apparatus 70 can include multiple processors or can be a single processor having one or more processing elements. The raw pixel values from the sensing apparatus 50 represent at least one illumination parameter such as illumination intensity and/or spectral characteristics of the reflected light 68 captured in the two-dimensional images recorded by sensing apparatus 50. The processing apparatus 70 uses the raw pixel values to determine the surface gradients of the coin surface 21.

Each surface gradient is a vector defining the slope of the coin surface 21 at a given spatial location and includes information identifying both the surface tilt and the surface orientation. The surface tilt refers to the angle between the surface normal vector at the given spatial location and the normal 19 to the surface 21. The surface orientation refers to the direction that the surface 21 is facing. From the surface gradient information, the processing apparatus 70 reconstructs a three-dimensional image of the shape of the surface 21 of coin 20 by finding a set of surface heights that are consistent with the surface gradient information.

The processing apparatus 70 additionally includes a memory 76. The reconstructed three-dimensional image 28 or 29 can be stored in a computer-readable medium for later processing. The computer-readable medium can be a memory device, such as a disk drive, random access memory (RAM), read-only memory (ROM), compact disk, floppy disk or tape drive, or any other type of storage device. In an alternative embodiment, the memory 76 is located external to the processing element 70, wherein they communicate by an electrical connection, optical connection, wireless connection or a combination thereof.

Display 90 is in communication with the processing apparatus 70 via connection 74. Connection 74 is operable to transmit three-dimensional image signals to display 90. Display 90 is operable to receive the three-dimensional image signals and to display the three-dimensional markings 23 and 25 as three-dimensional images 28 and 29, respectively. The processing apparatus 70 is also in communication with the controller 80 via connection 73. Connection 73 is operable to transmit blocking/unblocking and sorting instructions. The controller 80 is in communication with guiding mechanism 94, via connection 82. A signal carried by connection 82 is operable to trigger a movement of the guiding mechanism 94.

The controller 80 is also in communication with releasable stop 92 via connection 81. A signal carried by connection 81 is operable to trigger an insertion or removal of the releasable stop 92 from the single groove slide 31. For clarity, the connection 82 between the controller 80 and the guiding mechanism 94 and the connection 81 between the controller 80 and the releasable stop 92 are shown only in FIG. 2, rather than in FIGS. 3-5.

If more than one coin 20 is to be inspected during a coin inspection event, the releasable stop 92 is pulled back from the single groove slide 31 to allow a first coin to roll further down the single groove slide 31. Then the releasable stop 92 is pushed into the single groove slide 31 to position a second coin in front of the illumination apparatus 40. Pushing the releasable stop 92 into and out of the single groove slide 31 continues until all the coins in a coin inspection event are illuminated by two or more pre-established light patterns. A coin inspection event is defined herein to include the insertion of coins for one action. For example, a first coin inspection event occurs when a user inserts one or more coins into input end 32 of the coin inspection system 11 to purchase one item, such as a candy bar. A second coin inspection event occurs when the user inserts an additional coin or coins into input end 32 of the coin inspection system 11 to purchase a second item after the first item has been delivered.

Guiding mechanism 94 includes two coin positioners 94A and 94 B in, on or near the coin passageway 30. The two coin positioners 94A and 94 B are activated via connection 82 to move across the coin passageway 30 near the region where the single groove slide 31 merges with the triple groove slide region 33. A space is maintained between the two coin positioners 94A and 94B so that the coin 20 can pass between coin positioner 94A and coin positioner 94B.

The coin inspection system 11 can be used to determine a monetary value and to sort coins in a bank. Alternatively, the coin inspection system 11 can be used to determine a monetary value of coins 20 inserted into a vending machine or game machine. In some cases, the manufactures of the vending machine or game machine choose to direct all the coins into one location regardless of the coin value. Alternatively, the coin inspection system 11 can be used in a gambling casino to determine a monetary value of tokens having a metal portion. The casino may choose to sort the tokens or not.

In one embodiment, the coin inspection system 11 does not include the display 90 and is thus less expensive. Some users, such as banks, casinos, vendors of vending machines or vendors of game machines, only want to determine a monetary value and to sort the coins 20. In another embodiment, the coin inspection system 11 does not include the display 90 and does not determine a monetary value of the coins 20. This embodiment is useful for users who only need to sort coins 20. In yet another embodiment, inspection system 11 does not include the display 90 and does not sort the inspected coins 20 but only determines a monetary value for a coin inspection event.

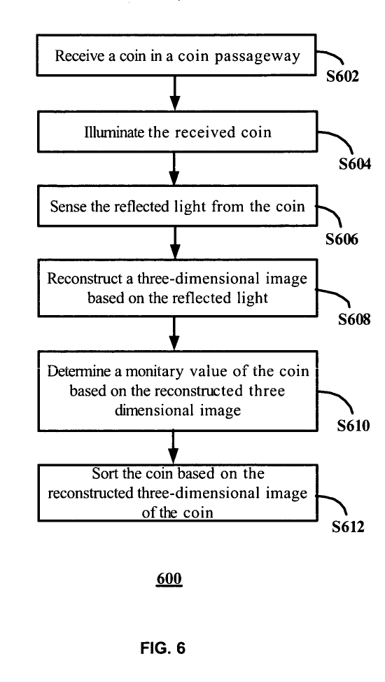

FIG. 6 is a flow chart 600 of a method according to the present invention for inspecting and sorting coins. The following discussion of flowchart 600 is related to exemplary coin inspection system 11 as shown in FIGS. 2-5. The stages S602-S612 describe the process in which a coin is illuminated, imaged in three-dimensions and sorted according to the reconstructed three-dimensional image.

During stage S602, a coin 20 is received in a coin passageway 30. The coin inspection system 11 functions when the coin passageway 30 is tilted with the input end 32 raised above the triple grooved slide region 33 so that gravity causes a coin 20 inserted into input end 32 to slide and/or roll down the single groove region 31 where it is stopped by the releasable stop 92, which is positioned to temporarily block further movement of the coin 20 down the single grooved slide 31. The force of the coin 20 on the releasable stop 92 causes an illumination request signal to be transmitted via connections 81 and 73 to the processing apparatus 70. The illumination request signal is then transmitted by processing apparatus 70 to the light control circuit 55 to initiate an illumination process by activating one or more of the light emitting elements 44-47 in sequential pre-established light patterns.

In an alternative embodiment, the signal that the coin 20 is in position for imaging is transmitted from a coin sensor on or near a portion of the coin passageway 30 to the processing apparatus 70. The sensor may be a pressure sensor, a motion sensor, a heat sensor, a vibration sensor, a light-beam-interruption sensor, or a combination thereof. A light-beam-interruption sensor senses a drop in an optical signal from an optical detector when an optical beam incident on the optical detector is blocked as the coin 20 moves along the single groove slide region 31.

In one embodiment, the coin sensor initiates transmission of an illumination request signal directly to the light control circuit 55.

During stage S604, the received coin 20 is illuminated when the light control circuit 55 receives a signal to sequentially generate two or more pre-established light patterns by activating one or more of the light emitting elements 44-47 in pre-established light patterns. The light 64-67 impinges on the surface 21 of coin 20 and is reflected as diffuse and specular light 68. As used herein, the term specular refers to a sharply defined light beam reflecting off a smooth surface, where the surface acts as a mirror, and the reflected beam travels in only one direction determined by the angle of incidence of the incident light, and the term diffuse refers to reflection from a rough surface in which the reflected light travels in all directions. The light emitting elements 44-47 produce an illumination gradient across a contiguous portion of the light emitting elements 44-47 as described in U.S. patent application Ser. No. 10/392,758 of Richard L. Baer, et al. entitled Optical Inspection System, Illumination Apparatus and Method for Use in Imaging Specular Objects Based on Illumination Gradients (Agilent Docket No. 10021084-1) filed on Mar. 20, 2003 and U.S. patent application Ser. No. 10/392,990 of Dietrich W. Vook entitled Optical Inspection System, Illumination Apparatus and Method for Reconstructing Three-dimensional Images for Printed Circuit Board and Electronics Manufacturing Inspection (Agilent Docket No. 10030418-1) filed on Mar. 20, 2003, both applications being incorporated by reference herein.

Referring to FIGS. 3 and 4, the light emitting elements 44-47 are shown herein as elements disposed in a circular array around a conical axis 49. The conical axis 49 and the normal 19 to the surface 21 are positioned with an illumination angle □. The illumination angle □ must be less than a few degrees and is preferably less than one half of a degree. The light emitting elements 44-47 are configured as described in the above mentioned patent applications.

The light 64-67 is depicted as single rays of light from light emitting elements 44-47 to schematically show that the light 64-67 is incident on a portion of the surface 21. Each light emitting element 44-47 emits light and includes a plurality of light emitting elements that have the same or different emission wavelengths. In an alternative embodiment, each light emitting element 44-47 includes light emitting element sections that each include one or more contiguously positioned light emitting elements. In the latter embodiment, the light emitting element sections each emit light.

The illumination apparatus 40 is designed to illuminate the coin 20, such that at least one illumination parameter has an illumination gradient with respect to that illumination parameter. For example, the illumination parameter can be the illumination intensities of the light emitting elements 44-47 and/or the spectral characteristics of the light emitting elements 44-47. The illumination intensities of the individual light emitting elements 44-47 in the illumination apparatus 40 are capable of varying gradually in order to produce an illumination intensity gradient sufficient to enable the surface gradient at a particular spatial (x,y,z) location on the surface 21 of the coin 20 to be estimated from the intensity of the specularly reflected light from that spatial location.

The light emitting elements 44-47 can be any suitable source of light 64-67. For example, the light emitting elements 44-47 can include one or more point light sources, one or more collimated light sources, one or more illumination arrays, such as one or more circular arrays of light-emitting diodes, or any other illumination source suitable for use in coin inspection system 11. The illumination intensity can be constant. In one embodiment, the intensity of the light 64 emitted by one or more of the light-emitting elements 44-47 is controlled by a light control circuit 55. In another embodiment, the wavelength of the light 64-67 emitted by the illumination apparatus 40 is controlled by the light control circuit 55 and/or chosen based on a number of factors, including manufacturer preferences. For example, some manufacturers may prefer the least expensive light emitting elements 44-47, which may be a red light emitting diode.

In one embodiment, the light emitting elements 44-47 are disposed in concentric circular arrays around the conical axis 49. In this embodiment, the light-emitting elements 44-47 within the illumination apparatus 40 nearest the small opening 42 have the lowest intensity and the light-emitting elements 44-47 within the illumination apparatus 40 nearest the large opening 41 have the highest intensity. It should be understood that in other embodiments the illumination intensity gradient is reversed. It should also be understood that numerous other illumination gradients are achievable, depending on the user or manufacturer preferences.

The coin 20 is held by the releasable stop 92 on the coin passageway 30 in a constant spatial relationship with the sensing apparatus 50 while the two or more pre-established light patterns are incident on surface 21. The controller 80 includes one or more solenoids operable to push releasable stop 92 into a position that blocks the coin and then to pull releasable stop 92 into a position that does not block the coin 20. In an alternative embodiment, the controller 80 includes a voltage source to apply a voltage to one or more piezo-electric based releasable stops 92. Releasable stop 92 maybe formed from any suitable rigid or semi-rigid material, such as metal, ceramic, plastic or a combination thereof.

During stage S606 of FIG. 6, the sensing apparatus 50 senses the light 68 reflected from the coin 20. Image data is obtained from each reflection of the two or more pre-established light patterns when a portion of the reflected light 68 is incident on the sensing apparatus 50. The reflected light 68 can be specular, diffuse or a combination of specular and diffuse.

The sensing apparatus 50 provides image data which includes raw pixel values representing at least one illumination parameter, such as the illumination intensity and/or spectral characteristics, of the reflected light 68 captured in the two-dimensional images recorded by the sensing apparatus 50. When the sensing apparatus 50 captures an image of the surface 21 of the coin 20, the image contains contributions from a range of light emitting elements 44-47 locations within the conical element 43. The extent of this range of locations depends on such factors as the focal length, magnification and f-number of the lens 39, and the distance between the coin 20 and the conical element 43. The light from the light emitting elements 44-47 contained inside of this range of locations is integrated together in the image, causing uncertainty in the correspondence between pixel level and light source location. However, if the illumination intensities are designed to vary linearly with incidence angle, the average value of the intensity is unaffected by this uncertainty except at the ends of the incidence angle range between illumination arrays 220.

The intensity of the actual received reflected light depends on other factors, such as the surface reflectivity and the distance between the coin 20 and the light emitting elements 44-47. The amount of information that is available in a single image may be insufficient to account for these factors. Therefore, in some embodiments, a single image under a fixed illumination gradient may not be adequate to measure the surface gradients of the coin 20. In this case, two or more images under different illumination gradients can be used to reduce the sensitivity of the measurements to the reflectivity of the surface 21 of the coin 20, or to the area of the object surface that has a particular surface gradient.

Image data representing the two or more two-dimensional images recorded by the sensing apparatus 50 is transmitted via connection 71 to a processing apparatus 70.

During stage S608, a three-dimensional image is reconstructed based on the reflected light 68 incident on the sensing apparatus 50. The processing apparatus 70 analyzes the transmitted image data and reconstructs a three-dimensional shape of the surface 21 of the coin 20. The processing apparatus 70 uses the raw pixel values to determine surface gradients of the surface 21. Each surface gradient is a vector defining the slope of the object surface at a given spatial location, and includes information identifying both the surface tilt and the surface orientation. From the surface gradient information, the processing apparatus 70 reconstructs a three-dimensional image 28 or 29 of the shape of the surface 21 by finding a set of surface heights that are consistent with the surface gradient information.

Undesired sensitivities can be normalized out by dividing corresponding pixel values from pairs of images collected from two or more images under different illumination gradients. The surface gradients can be determined by relating the measured ratio values in the image to the intensity characteristics of the light emitting elements 44-47.

The uncertainty in the measured surface gradient is also dependent in part on the size of the small opening 42. If the lighting pattern is spatially varied continuously, the highest possible measurement precision occurs when the small opening 42 is infinitely small. However, with a pinhole small opening 42, a limited amount of light enters the sensing apparatus 50, and therefore, a longer exposure is needed, resulting in additional sensor noise. Therefore, the size of the small opening 42 chosen can be a trade-off between the level of noise in camera measurements and the level of built-in uncertainty in surface gradient measurement.

In general, the surface gradient of the coin 20 at a particular spatial location on the surface of the coin is determined from the geometrical relationship between the angle of incidence of light illuminating the surface at that spatial location and the angle of reflection of the light that passes through the small opening 42 and into the sensing apparatus 50 via a lens 39. The angle of reflection is known based on the relative position between the sensing apparatus 50 and the coin 20. The identity of the light emitting elements 44-47 is determined from the recorded light level at a pixel or group of pixels in the sensing apparatus 50 corresponding to the spatial location of the object. A simple geometrical calculation determines the surface gradient that would direct light from a specific light emitting elements 44-47 to a pixel in the sensing apparatus 50.

The three-dimensional image 28 or 29 of surface 21 of coin 20 can be displayed to a user of the coin inspection system 11 on a display 90. The display 90 can be a three-dimensional display, such as a sharp screen, 3-D ball, user glasses (e.g., 3-D glasses or virtual reality glasses), or other type of three-dimensional display. In other embodiments, the display 90 can be a “rocking” two-dimensional display that uses a rocking motion of the image 28 to rotate the image 28 to create a three-dimensional image in the mind of the observer. The rocking can be automatic or controlled by a user. In further embodiments, the display 90 can be a two-dimensional display that displays a two-dimensional projection of the three-dimensional image 45 allowing the user to rotate the angle of viewing to view the complete three-dimensional image. The viewing angle can be manipulated through a user interface (not shown), such as a joystick, virtual reality interface or other type of control. In addition, the user interface can enable the user to control the information presented on the display 90. For example, through the user interface, the user can select only certain portions of the image 28 to be displayed in 3-D. The display capability of coin inspection system 11 is desirable when the authenticity of a coin is to be determined by a user of the system or if features of a rare coin of antiquity are to be displayed for viewing by one or more users.

During stage S610, the processing apparatus determines a monetary value of the coin 21 based on the reconstructed three-dimensional image 28. Three-dimensional images of both front surface 21 and back surface 22 of various coins are stored in memory 76 with a correlated monetary value for each stored three-dimensional image. After the three-dimensional image is reconstructed by processing apparatus 70, the processing apparatus 70 searches for a match among the three-dimensional images of various coins stored in memory 76. When a match is found, the correlated monetary value for the stored image is retrieved.

If more than one coin 20 is inserted into the input end 32 during a coin inspecting event, the monetary value for each coin 20 inserted during the coin inspecting event is held in a cache of memory 76 while the processing apparatus 70 searches for a match between the reconstructed three-dimensional images of all the coins 20 in the coin inspecting event. When all the coins 20 in a single coin inspecting event have been matched, the retrieved monetary values are summed by a processor in the processing apparatus 70 to form a total monetary value.

If the coin inspection system 11 is used in a vending machine or game machine, the processing apparatus 70 can determine when the total monetary value meets or exceeds the required monetary value for a requested item or requested number of plays. The coin inspecting event is complete when there are no more coins 20 inserted in the input end 32 and/or when the total monetary value meets or exceeds the required monetary value for a requested item or requested number of plays. In one embodiment, the processing apparatus 70 triggers the return of one or more coins 20 to the user if the coin inspecting event indicates the coins 20 have a monetary value exceeding the required monetary value for a requested item or requested number of plays. Mechanisms for vending and game machines to return coins 20 to a user are known to those of ordinary skill in the art.

In one embodiment, the total monetary values for all the coin inspecting events of a system 11 over a period of time are stored in memory 76 of the processing apparatus 70. In this embodiment, the processing apparatus 70 is programmed so that a manager of a coin inspection system 11 can retrieve data on the total monetary value of the coins collected in the coin inspection system 11 over the monitored period of time. In one embodiment, a processor in processing apparatus 70 transmits a data signal for the total monetary value of the coins 20 over a wireless connection.

The computer-readable medium in memory 76 includes three-dimensional images of coins 20 for one or more country. Maintenance personnel are able to reprogram the coin inspection system 11 to inspect and sort new types of coins 20 without a hardware change. For example, three-dimensional images of coins 20 from new countries with the correlated monetary values can be downloaded to memory 76 with no hardware modification required. Likewise three-dimensional images of coins 20 from selected countries and the correlated monetary values are deleted from memory 76 with no hardware modification required for the coin inspection system 11. In one embodiment, the manager of the coin inspection system 11 reprograms the processing apparatus over a wireless connection. In an alternative embodiment, computer-readable medium includes three-dimensional images of partially metallic tokens for one or more casino.

During stage S612, the coins 20 are sorted based on the reconstructed three-dimensional image 28 or 29 of the coin 20. Referring to FIGS. 2-5, the processing apparatus 70 transmits a signal via connection 73 to the controller 80 to activate movement of the guiding mechanism 94. The signal transmitted via connection 73 is based on the determined monetary value of the coin 20 to be sorted. The controller 80 operates one or more solenoids to push the positioners 92A and 92B into a location in which the opening between positioners 92A and 92B is in front of branch 33A, 33B or 33C. The controller 80 controls the movement of positioners 92A and 92B via connection 82. In an alternative embodiment, the controller 80 applies a voltage via connection 82 to one or more piezo-electric based positioners 92A and 92B to move the positioners 92A and 92B.

If a coin 20 has a first monetary value, the signal transmitted via connection 73 activates the controller 80 to position the opening between positioners 92A and 92B in front of branch 33A as shown in FIG. 4. If a coin 20 has a second monetary value, the signal transmitted via connection 73 activates the controller 80 to position the opening between positioners 92A and 92B in front of branch 33B as shown in FIG. 5. If a coin 20 has a third monetary value, the signal transmitted via connection 73 activates the controller 80 to position the opening between positioners 92A and 92B in front of branch 33C.

After the opening between positioners 92A and 92B is in position for the determined monetary value, controller 80 directs the releasable stop 92 via connection 81 to withdraw from the single groove slide 31, the coin 20 rolls or slides towards the triple groove slide region 33 and passes through the opening between positioners 92A and 92B into one of the branches 33A, 33B or 33C.

In one embodiment, the coin 20 lies on a surface 21 or 22 rather than on the edge 26. In an alternative embodiment, the guiding mechanism 94 includes a series of positioners to direct coin 20 through a series of branching grooves. In this alternative embodiment, for example, grooves 33A-33C each branch into two or more grooves and the additional grooves each branch into two or more grooves. In this multiple branch configuration, the guiding mechanism 94 includes positioners located at each branching-grooves region.

In an alternative embodiment, a surface of the coin passageway 30 includes one or more conveyer belts to carry the coin 20 from single groove slide 31 to one of the triple groove branches 33A, 33B or 33C.

In an alternative embodiment, a surface of the coin passageway 30 includes a main conveyer belt to hold coin 20 on a surface 21 or 22 during the illumination process and receiving conveyer belts for sorting the coin 20. Coin 20 is guided into a position by positioners 92A and 92B at the region where the main conveyer belt feeds a coin 20 onto a receiving conveyer belt. In an alternative embodiment, coin 20 on a main conveyer belt is guided onto a final conveyer belt through a series of positioners guiding the coin 20 through a series of receiving conveyer belts.

The positioners 92A and 92B may be formed from rubber, metal, plastic or any material firm enough to guide a coin 20. The positioners 92A and 92B are flexible or rigid. The ends which form the opening between positioners 92A and 92B may be tapered, rounded or beveled in a manner to reduce friction between positioner 92A, positioner 92B and the coin 20 and to enhance guiding functionality of the positioners 92A and 92B. In one embodiment, positioners 92A and 92B are configured so that positioner 92A is not parallel to positioner 92B.

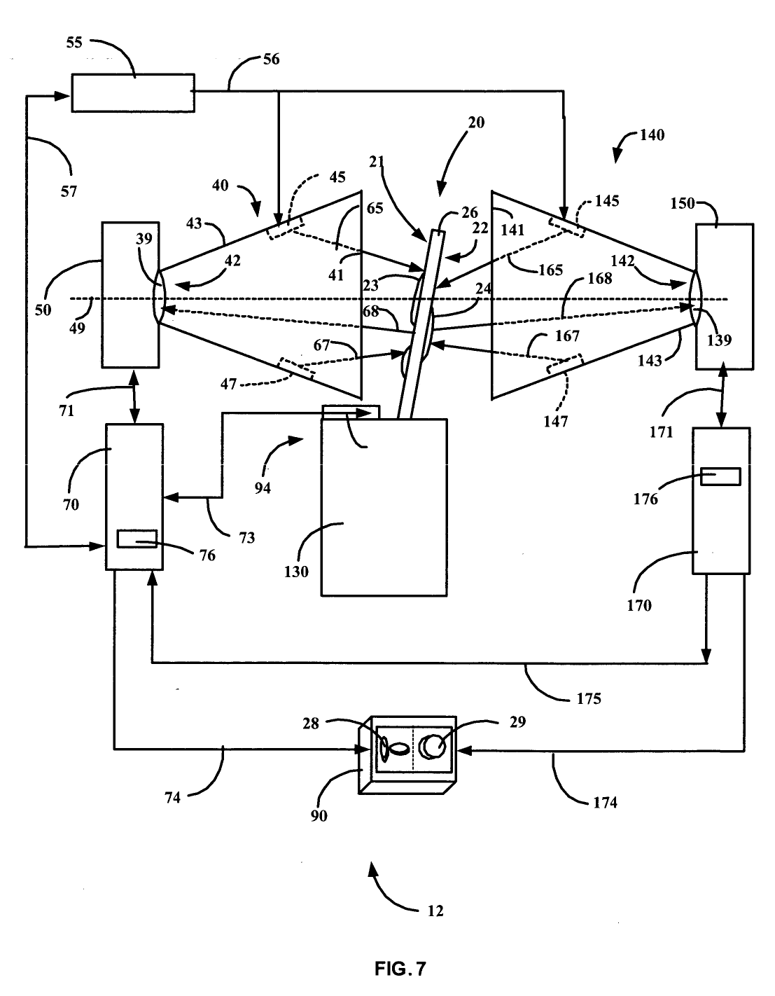

FIG. 7, in which like elements share like reference numbers with FIG. 3, shows a schematic cross sectional view of a coin inspection system 12 according to a second embodiment of the invention. The coin inspection system 12 examines the two faces of the coin 20 simultaneously. Coin inspection system 12 is required for coins that have a non-unique side. Coin inspection system 12 examines both sides of the coin 20 to ensure an examination of the coin's unique side. In coin inspection system 12, illumination apparatus 40 illuminates surface 21 of coin 20 while illumination apparatus 140 illuminates surface 22 of coin 20.

The coin passageway 130 is a conveyer system operable to position the surface 21 in front of the illumination apparatus 40 and surface 22 in front of illumination apparatus 140. The coin passageway 130 includes the coin passageway 30, releasable stop 92 and guiding mechanism 94 which have the same configuration and operation as described in FIGS. 2-5.

The illumination apparatus 140, sensing apparatus 150 with lens 139, processing apparatus 179 and memory 176 have similar structures, functions, and methods of operating to illumination apparatus 40, sensing apparatus 50, processing apparatus 79 and memory 76 as described in FIGS. 2-6.

Illumination apparatus 140 includes a conical element 143 with a large opening 141 opposing a small opening 142. Large opening 141 and small opening 142 are aligned about conical axis 49. Light emitting elements 145 and 147 are positioned within the conical element 143. A light sensitive region of the sensing apparatus 150 is positioned next to the small opening 142 to receive the reflected light 168 after it is transmitted through the lens 139.

A light control circuit 55 is in communication with the light emitting elements 44, 45, 46, 47 of the illumination apparatus 40 and light emitting elements 145 and 147 of the illumination apparatus 140 via connection 56. The light control circuit 55 is also in communication with the processing apparatus 70 via connection 57. Connection 57 is operable to transmit a signal from processing apparatus 70 instructing light control circuit 55 to selectively activate the one or more of the light emitting elements 44, 45, 46, 47, 145 and 147 in pre-established light patterns. Connection 57 is also operable to transmit a completion signal to processing apparatus 70 after the illumination patterns are completed. The pre-established light patterns have respective illumination gradients, which are incident on surface 21 and surface 22 of coin 20. The pre-established light patterns of light emitting elements 44, 45, 46, 47 are the same as the pre-established light patterns of light emitting elements 145 and 147. In an alternative embodiment, the pre-established light patterns of light emitting elements 44, 45, 46, 47 are different from the pre-established light patterns of light emitting elements 145 and 147. Alternative embodiments for light emitting elements 145 and 147 are the same as the alternative embodiments for light emitting elements 14, 45, 46, 47 as described in the discussion of stage S604 in FIG. 6.

In FIG. 7, connection 56 is representative of a connection to each and every light emitting element 44, 45, 46, 47, 145 and 147 for separate control of each and every light emitting element 44, 45, 46, 47, 145 and 147. In one embodiment, a first light control circuit separately controls of each and every light emitting element 44, 45, 46, 47 and second light control circuit separately controls of each and every light emitting element 145 and 147.

The sensing apparatus 150 is in communication with the processing apparatus 170 via connection 171. Connection 171 is operable to transmit image data sets to the processing apparatus 170. Connection 171 is also operable to transmit synchronizing signals from the processing apparatus 170 to sensing apparatus 150. Connections 175 and 57 are operable to transmit synchronizing signals from the processing apparatus 170 through processing apparatus 70 to light control circuit 55. The synchronizing signals synchronize the generation of the appropriate illumination gradients by the illumination apparatus 140 with the sensing of the reflected light 168 by the sensing apparatus 150.

Processing apparatus 170 is in communication with display 90 via connection 174. Connection 174 is operable to transmit three-dimensional image signals for image 29 to display 90. Display 90 is operable to receive the three-dimensional image signals and to display the three-dimensional image 28 and three-dimensional image 29 of the three-dimensional markings 23 and 24, respectively, as described herein.

The processing apparatus 170 is also in communication with a processing apparatus 70 via connection 175. Connection 175 is operable to transmit a monetary value to apparatus 70. For example, processing apparatus 170 can inform processing apparatus 70 about a monetary value after finding a match with one of the three-dimensional images of various coins stored in the memory 176 of processing apparatus 170. This monetary value transmitted as data via connection 175 provides a confirmation to the monetary value determined by processing apparatus 70. The method of sorting the coin 20 in coin inspection 12 proceeds as described herein for coin inspection system 11.

In one embodiment, sensing apparatus 150 is in communication with the processing apparatus 70, which is operable to reconstruct a three-dimensional image of surface 22 based on the reflected light 168. In this embodiment, the image signal for three-dimensional image 29 is transmitted to display 90 via connection 74.

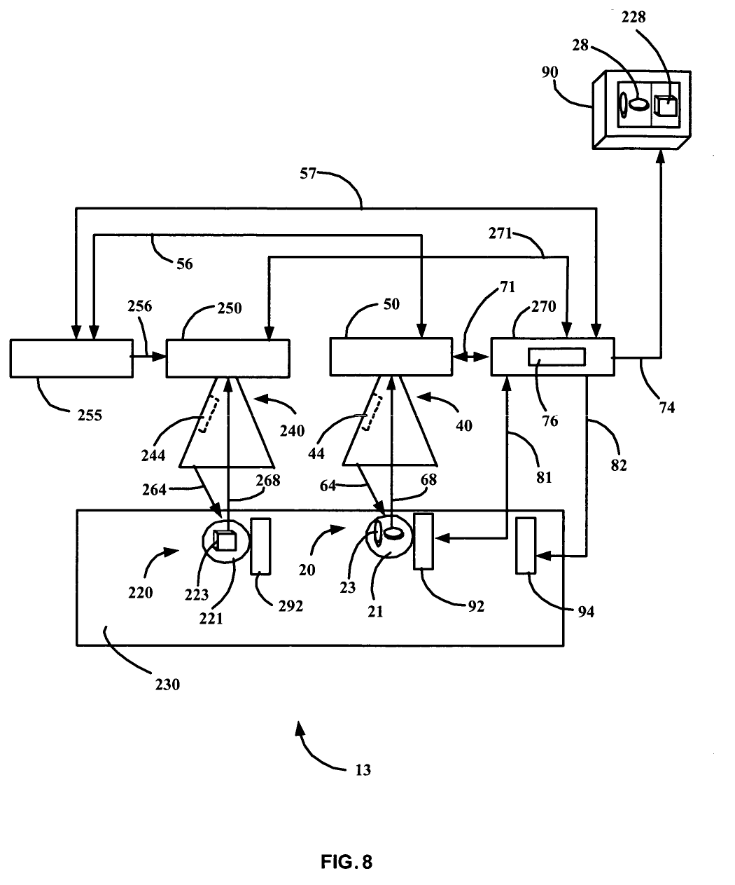

FIG. 8, in which like elements share like reference numbers with FIGS. 1 and 2, is a block diagram of a coin inspection system 13 according to a third embodiment of the invention. The coin inspection system 13 has the capability to examine more than one coin at once.

Coin inspection system 13 includes a coin passageway 230, illumination apparatus 40 and illumination apparatus 240, sensing apparatus 50 and a sensing apparatus 250 and processing apparatus 270. The illumination apparatus 240 illuminates at least one coin 220 positioned on, in or within coin passageway 230 with light 264 while illumination apparatus 40 illuminates at least one coin 20 positioned on, in or within coin passageway 30 with light 64. Surface 221 of coin 220 has three-dimensional markings 223.

The structure, function and method of operating illumination apparatus 240 is similar to the illumination apparatus 40 described in FIGS. 2-5 as is understandable to those of ordinary skill in the art.

A light control circuit 255 is in communication with the illumination apparatus 50 via connection 56 and with illumination apparatus 250 via connection 256. Light control circuit 255 is in communication with the processing apparatus 270 via connection 57. The light control circuit 255 operates with light emitting elements 44 and 244 of the illumination apparatus 40 and 240, respectively, as described for FIGS. 2-6. The light emitting element 244 has a structure, function and method of operating similar to that of light emitting element 44 as described for FIGS. 2-6.

The sensing apparatus 50 is positioned to receive light 68 reflected from the coin 20. The sensing apparatus 250 is positioned to receive light 268 reflected from the coin 220. Sensing apparatus 50 and 250 may be a camera or CCD array. The sensing apparatus 50 and 250 are in communication with the processing apparatus 270 via connection 71 and 271, respectively. Connections 71 and 271 are operable to transmit image data representing two or more two dimensional images recorded by sensing apparatus 20 and sensing apparatus 270, respectively.

Connections 71 and 271 are also operable to transmit synchronizing signals from the processing apparatus 270 to sensing apparatus 50 and 250, respectively. Connection 57 is operable to transmit synchronizing signals from the processing apparatus 270 to light control circuit 255. The synchronizing signals synchronize the generation of the appropriate illumination gradients by the illumination apparatus 40 and illumination apparatus 240 with the sensing of the reflected light 68 and reflected light 26, respectively.

The processing apparatus 270 is operable to reconstruct a three-dimensional image of the coin 20 based on the reflected light 68, to determine a monetary value of the coin 20 and to direct movement of coin 20. The processing apparatus 270 is also operable to reconstruct a three-dimensional image of the coin 220 based on the reflected light 268, to determine a monetary value of the coin 220 and to direct movement of coin 220. The processing apparatus 270 includes a memory 76. Specifically, processing apparatus 270 reconstructs three-dimensional images 28 and 228 of markings 23 and markings 223, respectively. Processing apparatus 270 is in communication with display 90 via connection 74, which is operable to transmit image signals for the three-dimensional images 28 and 228 to display 90. Display 90 is operable to receive the three-dimensional image signals and to display the three-dimensional image 28 and three-dimensional image 228 of three-dimensional markings 23 and 223, respectively.

The processing apparatus 270 is in communication with a releasable stop 92 and a guiding mechanism 94, via connections 81 and 82, respectively. The processing apparatus 270 is also in communication with a releasable stop 292 via a connection, which is not shown in FIG. 8 for clarity.

The releasable stop 92 positioned in the coin passageway 230 is operable to hold the coin 20 in position in front of the illumination apparatus 40. The releasable stop 292 positioned in the coin passageway 230 is operable to hold the coin 220 in position in front of the illumination apparatus 240. The guiding mechanism 94, which is positioned in, on or near the coin passageway 30, is operable to direct coins 20 and 220 for sorting based on the respective monetary value determined for coins 20 and 220.

Connections 56, 57, 71, 74, 81 and 82, 271 may be electrical connections, such as metallic wires and printed circuit board traces, optical connections, such a optical waveguides or optical fibers, wireless connections, such as WiFi, or a combination thereof.

During an inspection process, the releasable stop 292 intersects a portion of the single groove slide 31 to position the coin 220 in front of the illumination apparatus 240 while releasable stop 92 positions the coin 20 in front of the illumination apparatus 40. Thus coin 20 and coin 220 are held in a constant spatial relationship with the sensing apparatus 50 and sensing apparatus 250, while the two or more pre-established light patterns are incident on surface 21 and 221.

In one embodiment, a first processing apparatus is in communication with sensing apparatus 50, a second processing apparatus is in communication with sensing apparatus 250 and the first processing apparatus communicates with the second processing apparatus.

When two coins 20 and 220 are inserted into input end 32 to slide and/or roll down the single groove region 31, coin 20 is stopped by the releasable stop 92, while coin 220 is stopped by releasable stop 292. The pressure of the coin 20 on the releasable stop 92 triggers a signal to be transmitted via connection 81 to the processing apparatus 270 to request the light control circuit 255 to sequentially illuminate two or more pre-established light patterns by activating one or more of the light emitting elements 44 in pre-established light patterns. In a similar manner, the pressure of the coin 220 on the releasable stop 292 triggers a signal to be transmitted, via a connection that is not shown, to the processing apparatus 270 to request the light control circuit 255 to sequentially illuminate two or more pre-established light patterns by activating one or more of the light emitting elements 244 in pre-established light patterns. When both the coins 20 and 220 have been illuminated with the two or more pre-established light patterns, the releasable stop 92 and releasable stop 292 are removed from the single groove slide 31.

Coin 20 is sorted into one branch of the triple groove branch region 33, for example, branch 33A, and then coin 220 is sorted into a branch of the triple groove branch region 33, for example, branch 33B. The controller 80 controls the position of the guiding mechanism 94 above based on the monetary value of coins 20 and 220. In one embodiment, an additional releasable stop holds coin 220 in single groove 31 while coin 20 is sorted and then releases coin 220 for sorting. Controller 80 controls the additional releasable stop, as will be understood by those of ordinary skill in the art.

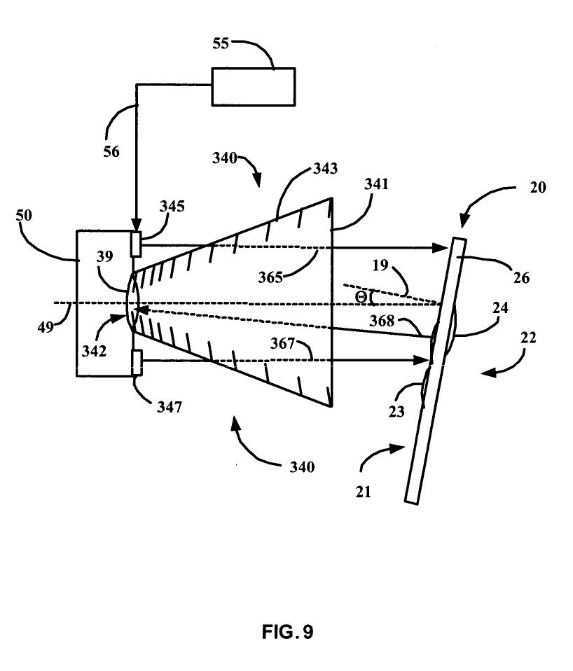

FIG. 9 is a side view of another embodiment of the illumination apparatus 340 for use in a coin inspection system of FIGS. 2-8 according to the invention. Illumination apparatus 340 is operable to replace illumination apparatus 40, illumination apparatus 240 and/or illumination apparatus 140 in coin inspection systems 10-13. Illumination apparatus 340 is shown in FIG. 9 with sensing apparatus 50, lens 39 and coin 20.

Illumination apparatus 340 includes a conical element 343, at least one light emitting element 345 and 347, and a light control circuit 55 connected to the light-emitting elements 345 and 347 to selectively activate the light emitting elements 345 and 347.

The conical element 343 has a small opening 342 that opposes a large opening 341. Large opening 341 and small opening 342 are aligned about a conical axis 49. The conical element 343 is positioned between light emitting elements 345 and 347 and the coin 20. The large opening 341 is positioned to transmit light 365 and 367 from the light emitting elements 345 and 347, respectively, upon a surface 21 of the coin 20. Light 365 and 367 are depicted as single rays of light from light emitting elements 345 and 347 to schematically show that the light 365-367 is incident on a portion of the surface 21. The conical axis 49 and the normal 19 to the surface 21 are positioned with an illumination angle □. The illumination angle □ is generally less than a few degrees and is preferably less than one half of a degree.

Light 368 is reflected from the surface 21 of coin 20. The sensing apparatus 50 is positioned in proximity to the small opening 342 and is operable to obtain images of light 368 reflected from the coin 20 under two or more respective illumination gradients while the coin 20 is maintained in a constant spatial relationship with the sensing apparatus 50.

The conical element 343 has a gradient of optical transparency across at least a contiguous portion of the conical element 343. This gradient is schematically indicated by a non-uniform pattern of hatch marks on the sides of conical element 343. When light emitted from a light emitting elements 345 and 347 is incident on the outer surface of conical element 343, the intensity of the transmitted light 365 and 367 is a function of the incident position and incident angle of the incident light. The intensity of the transmitted light 365 and 367 is also a function of the wavelength of the light 365 and 367, if the optical transmission characteristics of the material forming the conical element 343 are wavelength dependent. The transmitted light 365 and 367 has a pre-established light pattern with a respective illumination gradient based on the optical transparency gradient of the conical element 343 and the illumination pattern of the light emitting elements 345 and 347.

The optical transparency of the conical element 343 nearest the small opening 342 is at a low end of the transparency range, i.e., highly absorbing of light, and the optical transparency of the conical element 343 nearest the large opening 341 is at the high end of the transparency range, i.e., not highly absorbing of light. In other embodiments, the optical transparency gradient of the conical element 343 is reversed. Numerous other optical transparency gradient patterns in the conical element 343 can be utilized, depending on the user or manufacturer preferences.

The conical element 343 may be formed from glass or optically transparent plastics and coated with thin films, including thin metallic and/or dielectric films, to provide a gradient of optical transparency.

Each of the light emitting elements 345 and 347 emits light. In one embodiment, light emitting elements 345 and 347 include a plurality of light emitting elements that have the same or different emission wavelengths. The light emitting elements 345 and 347 can be any suitable source of light 365 and light 367. For example, the light emitting elements 345 and 347 can include one or more point light sources, one or more collimated light sources; one or more illumination arrays, such as one or more circular arrays of light-emitting diodes, or any other illumination source suitable for use in coin inspection system 11, 12 or 13.

In one embodiment, the illumination intensity is constant for each light emitting elements 345 and 347. In another embodiment, the intensity of the light 365 and 367 emitted by one or more of the light emitting element 345 and 347 within the illumination apparatus 340 is varied by the light control circuit 55. In that case the light control circuit 55 transmits control signals via connection 56. In addition, the wavelength of the light 365 and light 367 emitted by the illumination apparatus 340 can be controlled by the light control circuit 55 and/or chosen based on a number of factors.

In one embodiment, the light emitting elements 345-347, arranged in a circular array around the conical axis 49, are divided into sections. Each of the sections independently illuminates the coin. In one embodiment, the light emitting elements 345-347 within a section all have the same emission wavelength. In another embodiment, the light emitting elements 345-347 are disposed in concentric circular arrays around the axis 49.

In an alternative embodiment, coin inspection systems 11-13 additionally include the conventional coins inspection techniques such as weight, size and electromagnetic properties.

While the embodiments of the invention disclosed herein are presently considered to be preferred, various changes and modifications can be made without departing from the scope of the invention. The scope of the invention is indicated in the appended claims and all changes that come within the meaning and range of equivalents are intended to be embraced therein.

We claim:

1. A coin inspection system, comprising:
a coin passageway;
an illumination apparatus to illuminate at least one coin positioned on the coin passageway;
a sensing apparatus positioned to receive light reflected from the coin; and
a processing apparatus to reconstruct a three-dimensional image of the coin based on the reflected light.

2. The coin inspection system of claim 1, in which the coin passageway comprises:
a conveyer system operable to convey the coin before the illumination apparatus.

3. The coin inspection system of claim 2, in which the conveyer system further comprises:
a grooved slide to hold the coin; and
a releasable stop to position at least one surface of the coin before the illumination apparatus.

4. The coin inspection system of claim 2, in which the coin passageway further comprises a guiding mechanism in proximity to the conveyer system operable to direct the coin into a channel based on the monetary value of the coin.

5. The coin inspection system of claim 1, in which the illumination apparatus comprises:
light-emitting elements disposed in concentric circular arrays around an axis orthogonal to a plane of a surface of the coin, the light-emitting elements producing an illumination gradient across at least a contiguous portion of the light-emitting elements; and
a light control circuit connected to the light-emitting elements to selectively activate the light-emitting elements in pre-established light patterns.

6. The coin inspection system of claim 5, in which the sensing apparatus is operable to obtain images of light reflected from the coin under the illumination gradients while the coin is maintained in a constant spatial relationship with the sensing apparatus.

7. The coin inspection system of claim 5, in which the light emitting elements are one of light emitting diodes, edge-emitting lasers, vertical-cavity-surface-emitting lasers, incandescent light sources with color filters and any combination thereof.

8. The coin inspection system of claim 1, in which the sensing apparatus is one of a camera and a CCD array.

9. The coin inspection system of claim 1, in which the illumination apparatus comprises:
at least one light emitting element;
a light control circuit connected to the light-emitting element to selectively activate the light emitting element; and
a conical element having a gradient of optical transparency across at least a contiguous portion of the conical element, in which the conical element is positioned between the light emitting element and the coin.

10. The coin inspection system of claim 9, in which the conical element has a small opening opposite a large opening, the small opening and large opening are aligned about a conical axis, and the large opening is positioned to transmit light from the light emitting element upon a surface of the coin.

11. The coin inspection system of claim 9, in which the at least one light emitting element comprises light emitting elements arranged in a circular array around the conical axis, the circular array being divided into sections, each of the sections independently illuminating the coin.

12. The coin inspection system of claim 11, in which each of the sections comprises light emitting elements having the same emission wavelength.

13. The coin inspection system of claim 9, in which the sensing apparatus is positioned in proximity to the small opening and is operable to obtain images of light reflected from the coin under two or more respective illumination gradients while the coin is maintained in a constant spatial relationship with the sensing apparatus.

14. The coin inspection system of claim 1, in which the illumination apparatus comprises more than one illumination apparatus.

15. The coin inspection system 11 of claim 1, in which the processing apparatus to determine a monetary value comprises:
a memory to store a database comprising coin images from a particular country.

16. A method for inspecting coins, the method comprising:
receiving a coin on a coin passageway;
illuminating the coin;
sensing reflected light from the coin; and
reconstructing a three-dimensional image based on the reflected light.

17. The method of claim 16, further comprising:
sorting the coin based on the reconstructed three-dimensional image.

18. The method of claim 16, further comprising:
determining a monetary value of the at least one coin based on the reconstructed three-dimensional image.

19. The method of claim 16, further comprising:
storing the reconstructed three-dimensional image in memory.

20. A coin inspection system comprising:
means for receiving a coin on a coin passageway;
means for illuminating the coin;
means for sensing reflected light from the coin; and
means for reconstructing a three-dimensional image based on the reflected light.
